(19) United States
(12) Patent Application Publication
(10) Pub. No.: US 2009/0035641 A1
(43) Pub. Date: Feb. 5, 2009

(54) FUEL CELL DEVICE

(75) Inventors: Jin-Shu Huang, Hsinchu (TW); Ching-Po Lee, Hsinchu (TW); Cheng Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/962,111

(22) Filed: Dec. 21, 2007

(30) Foreign Application Priority Data
Jul. 30, 2007 (TW) 96127742

(51) Int. Cl. H01M 8/02; H01M 2/02

(52) U.S. Cl. 429/34

(57) ABSTRACT

A fuel cell device for being inserted into an expansion slot of an electronic device is provided. The fuel cell device includes a case, a first fuel cell module, second fuel cell modules, a connecting interface, and a power management module. The case is divided into a first part and a second part connected thereto. When the fuel cell device is inserted into the expansion slot, the first part is inside the expansion slot and the second part is outside the expansion slot. The first fuel cell module is disposed inside the first part and the second fuel cell modules are juxtaposed inside the second part. The connecting interface is disposed at the case, for being electrically connected to the expansion slot. The power management module is disposed inside the case, for being electrically connected to the first and the second fuel cell modules and the connecting interface.

### CROSS-REFERENCE TO RELATED APPLICATION

This application claims the priority benefit of Taiwan application serial no. 96127742, filed on Jul. 30, 2007. The entirety of the above-mentioned patent application is hereby incorporated by reference herein and made a part of this specification.

### BACKGROUND OF THE INVENTION

1. Field of the Invention

The present invention relates to a fuel cell device. More particularly, the present invention relates to a fuel cell device for being inserted into an expansion slot of an electronic device.

2. Description of Related Art

Fuel cells, having advantages of high efficiency, low noise, and no pollution, are of an energy technology following the trend of the age. Fuel cells are classified into many types, in which proton exchange membrane fuel cells (PEMFC) and direct methanol fuel cells (DMFC) are the common ones. Taking the DMFC as an example, a fuel cell module of the DMFC includes a proton exchange membrane and a cathode and an anode respectively disposed at two sides of the proton exchange membrane.

The DMFC uses an aqueous methanol solution as fuel, and reaction formulae of the DMFC are expressed as follows:

Anode: CH₃OH+H₂O→CO₂+6H⁺+6e⁻

Cathode: 3/2O₂+6H⁺+6e⁻→3H₂O

Overall reaction: CH₃OH+3/2O₂→CO₂+2H₂O

It can be known from the above reaction formulae, oxygen is required in the cathode reaction. If a sufficient amount of oxygen cannot be supplied to the cathode, the power generating efficiency of the DMFC is reduced significantly.

FIG. 1 is a schematic view of a conventional fuel cell device. Referring to FIG. 1, a conventional fuel cell device 100 is inserted into a slot of a thin optical disk drive of a notebook computer to provide power required by the notebook computer. The fuel cell device 100 mainly includes a case 110 and two fuel cell modules 120a, 120b. The case 110 is divided into a first part 112 and a second part 114 connected to the first part 112. When the fuel cell device 100 is inserted into the slot of the thin optical disk drive, the first part 112 is inside the slot and the second part 114 is outside the slot. The height of the interior space of the first part 112 is lower than that of the interior space of the second part 114. Further, the fuel cell modules 120a, 120b are juxtaposed in the interior space of the first part 112 along the height direction of the interior space of the first part 112. The two fuel cell modules 120a, 120b are separated by a certain distance, such that a flow channel C1 is formed between the fuel cell modules 120a, 120b. The fuel cell module 120a and a top 112b of the first part 112 are separated by a certain distance, such that a flow channel C2 is formed between the fuel cell module 120a and the top 112b. The fuel cell module 120b and a bottom 112c of the first part 112 are separated by a certain distance, such that a flow channel C3 is formed between the fuel cell module 120b and the bottom 112c.

The first part 112 has a gas inlet 112a, the second part 114 has a gas outlet 114a, and the fuel cell modules 120a, 120b are disposed between the gas inlet 112a and the gas outlet 114a. After entering the case 110 through the gas inlet 112a, airflow 170 passes through the fuel cell modules 120a, 120b via the flow channels C1, C2, C3, so as to provide oxygen required by the cathode to the fuel cell modules 120a, 120b. Thereafter, the airflow 170 flows out of the case 110 through the gas outlet 114a.

However, the height of the slot of the thin optical disk drive is not high, so the height L1 of the first part 112 of the case 110 is not high either. In conventional art, the minimum height of the slot of the thin optical disk drive is merely 12.7 mm. That is to say, the height L1 of the first part 112 of case 110 is less than 12.7 mm. Additionally, the minimum thickness of the fuel cell modules 120a, 120b is 5.2 mm, such that the height of each of the flow channels C1, C2, C3 are less than 0.5 mm. As thus, the oxygen supplied to the fuel cell modules 120a, 120b is relatively less, so the reaction efficiency of the fuel cell modules 120a, 120b is poor. That is to say, the power generating efficiency of the fuel cell device 100 is poor.

### SUMMARY OF THE INVENTION

Accordingly, the present invention is directed to provide a fuel cell device to improve power generating efficiency.

An embodiment of the present invention provides a fuel cell device for being inserted into an expansion slot of an electronic device. The fuel cell device includes a case, a first fuel cell module, a plurality of second fuel cell modules, a connecting interface, and a power management module. The case has a first part and a second part connected to the first part. When the fuel cell device is inserted into the expansion slot, the first part is inside the expansion slot and the second part is outside the expansion slot. The height of the interior space of the first part is lower than that of an interior space of the second part. The first fuel cell module is disposed in the interior space of the first part. The second fuel cell modules are arranged in the interior space of the second part along a height direction of the interior space of the second part, and the second fuel cell modules are separated from each other by a certain distance. The connecting interface is disposed at the case, for being electrically connected to the expansion slot. The power management module is disposed inside the case and electrically connected to the first fuel cell module, the second fuel cell modules and the connecting interface.

Merely one first fuel cell module is disposed in the interior space of the first part of the case of the fuel cell device, such that the reaction gas supplied to the first fuel cell module is increased. Further, as the height of the second part of the case is higher, a plurality of second fuel cell modules is disposed in the interior space of the second part, and a sufficient amount of reaction gas is still supplied to the second fuel cell modules. Therefore, the fuel cell device has preferable power generating efficiency.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional fuel cell device.

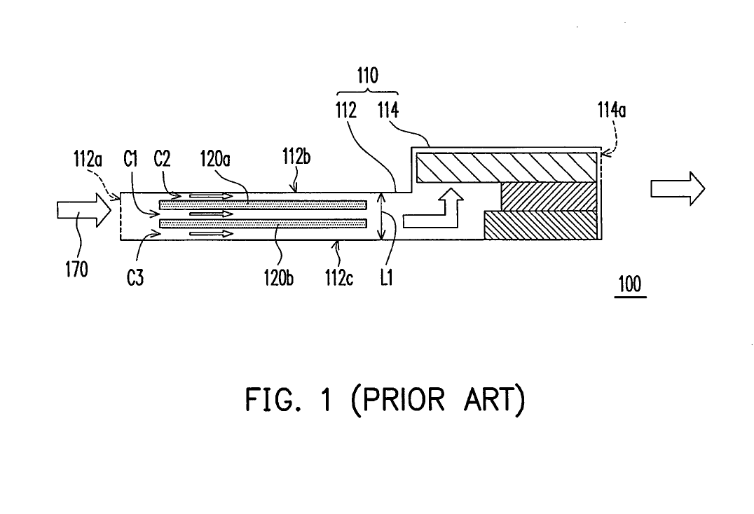

FIG. 2 is a schematic view of a fuel cell device according to an embodiment of the present invention combined to an electronic device.

FIG. 3 is a schematic sectional view of the fuel cell device in FIG. 2.

FIG. 4 is a schematic perspective view of the fuel cell device in FIG. 2.

FIG. 5 is a schematic sectional view of a fuel cell device according to another embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

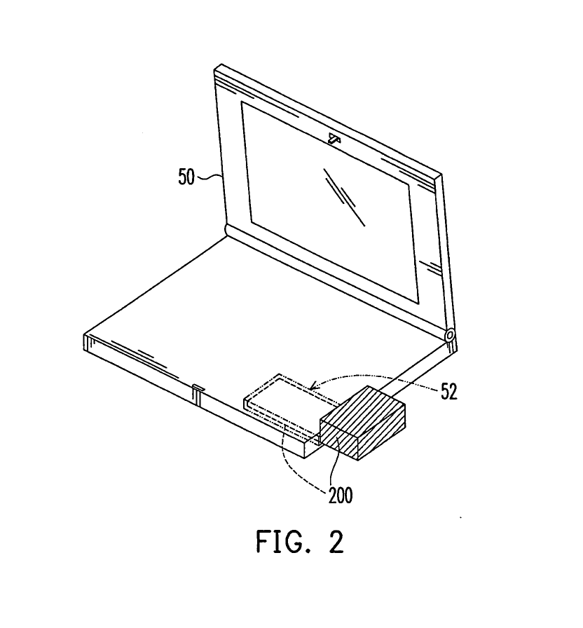

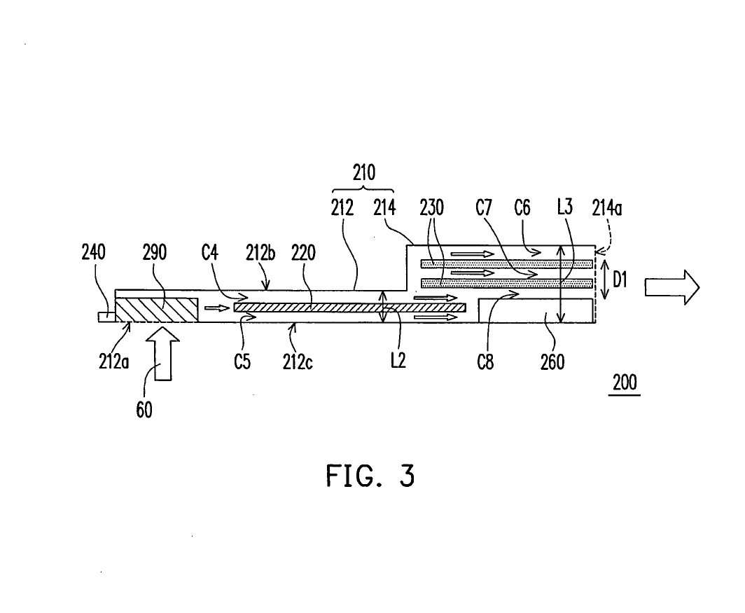

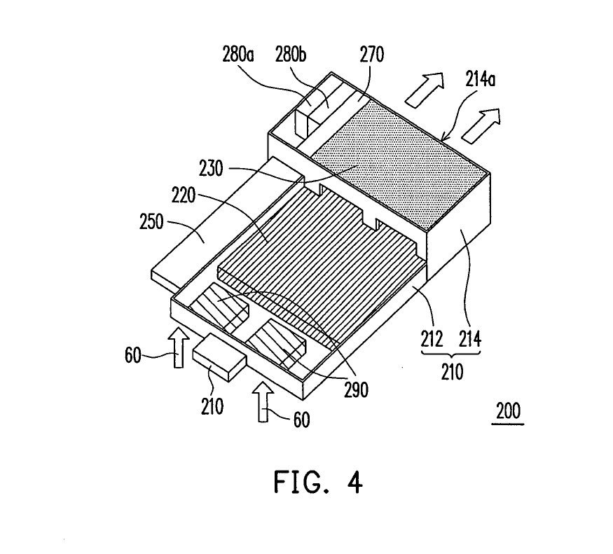

FIG. 2 is a schematic view of a fuel cell device according to an embodiment of the present invention coupled to an electronic device, FIG. 3 is a schematic sectional view of the fuel cell device in FIG. 2, and FIG. 4 is a schematic perspective view of the fuel cell device in FIG. 2. Referring to FIG. 2 to FIG. 4, a fuel cell device 200 of this embodiment is suitable for being inserted into an expansion slot 52 of an electronic device 50. The electronic device 50 is, for example, a notebook computer, and the expansion slot 52 is, for example, but not limited to, an optical disk drive slot. The fuel cell device 200 includes a case 210, a first fuel cell module 220, a plurality of second fuel cell modules 230 (in this embodiment, for example, two first fuel cell modules 230), a connecting interface 240, and a power management module 250. The case 210 has a first part 212 and a second part 214 connected to the first part 212. When the fuel cell device 200 is inserted into the expansion slot 52, the first part 212 is inside the expansion slot 52 and the second part 214 is outside the expansion slot 52. The height of the interior space of the first part 212 is lower than that of the interior space of the second part 214. The first fuel cell module 220 is disposed in the interior space of the first part 212. The second fuel cell modules 230 are arranged in the interior space of the second part 214 along a height direction D1 of the interior space of the second part 214 and are separated from each other by a certain distance. The connecting interface 240 is disposed at the case 210, for being electrically connected to the expansion slot 52. The power management module 250 is disposed in the case 210 and electrically connected to first fuel cell module 220, the second fuel cell modules 230, and the connecting interface 240.

Accordingly, the power management module 250 is, for example, disposed inside the interior space of the first part 212. The power management module 250 includes a boost DC/DC converter (not shown) and a control unit (not shown). The boost DC/DC converter is used to improve the voltage of the DC generated by the first fuel cell module 220 and the second fuel cell modules 230, such that the voltage of the DC supplied to the electronic device 50 via the connecting interface 240 matches the operating voltage of the electronic device 50.

Further, the fuel cell device 200 further includes a fuel cartridge 260, a mixing tank 270, a first pump 280a, and a second pump 280b. The fuel cartridge 260 and the mixing tank 270 are disposed in the case 210. Additionally, the mixing tank 270 is connected to the fuel cartridge 260, the first fuel cell module 220 and the second fuel cell modules 230. The first pump 280a is disposed in the case 210 for introducing the fuel in the fuel cartridge 260 into the mixing tank 270. The second pump 280b is disposed in the case 210 for introducing the fuel in the mixing tank 270 into the first fuel cell module 220 and the second fuel cell modules 230. Particularly, the fuel cartridge 260, the mixing tank 270, the first pump 280a, and the second pump 280b are disposed, for example, in the interior space of the second part 214. Further, the liquid (for example, water) generated during the reactions of the first fuel cell module 220 and second fuel cell modules 230 flows into the mixing tank 270.

In the fuel cell device 200, the first fuel cell module 220 and each of the second fuel cell modules 230 respectively includes two membrane electrode assemblies with the cathodes outside the fuel cell modules. Further, an output power of the first fuel cell module 220 is, for example, higher than that of each of the second fuel cell modules 230. A size of the first fuel cell module 220 is, for example, larger than that of each of the second fuel cell modules 230. Additionally, the first fuel cell module 220, for example, extends under the second fuel cell modules 230.

Further, the first part 212 provides a gas inlet 212a and the second part 214 provides a gas outlet 214a. The first fuel cell module 220 and the second fuel cell modules 230 are disposed between the gas inlet 212a and the gas outlet 214a. Additionally, the fuel cell device 200 further includes at least one fan 290 disposed between the first fuel cell module 220 and the gas inlet 212a and adjacent to the gas inlet 212a. In this embodiment, the fan 290 is, for example, a blower.

A flow channel C4 is formed between the first fuel cell module 220 and a top 212b of the first part 212, and a flow channel C5 is formed between the first fuel cell module 220 and a bottom 212c of the first part 212. When the fan 290 runs, airflow 60 enters the first part 212 of the case 210 through the gas inlet 212a and passes the first fuel cell module 220 through the flow channels C4, C5. And then, the airflow 60 passes the second fuel cell modules 230 and flows out of the case 210 through the gas outlet 214a.

Though the height L2 of the first part 212 is lower, in this embodiment, merely one first fuel cell module 220 is disposed in the interior space of the first part 212, the heights of the flow channels C4, C5 are relatively high. In other words, the spaces of the flow channels C4, C5 are relatively large, so the flow of the gas is relatively large. As such, the reacting gas (for example, oxygen) required by the cathode reaction is sufficiently supplied to the first fuel cell module 220 to improve the reaction efficiency of the first fuel cell module 220. Further, as the height L3 of the second part 214 is higher, even a plurality of second fuel cell modules 230 are disposed in the interior space of the second part 214, there is still sufficient space to form flow channels C6, C7, C8 in the interior space of the second part 214. Therefore, the reacting gas required by the cathode reaction is sufficiently supplied to the second fuel cell modules 230, so as to improve the reaction efficiency of the second fuel cell modules 230.

Based on the above description, as the first fuel cell module 220 and the second fuel cell modules 230 have relatively high reaction efficiency, the fuel cell device 200 has preferable power generating efficiency.

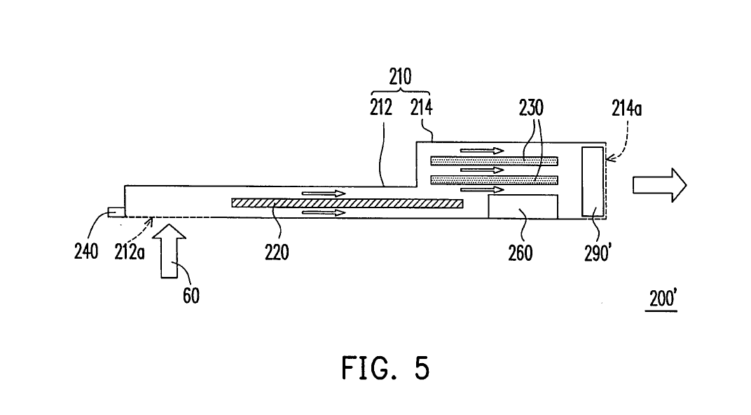

It should be noted that, the present invention is not meant to limit the sort of the fan 290 and the position for disposing the fan 290. In another embodiment (as shown in FIG. 5), a fan 290′ of a fuel cell device 200′ is, for example, disposed between the second fuel cell modules 230 and the gas outlet 214a and is adjacent to the gas outlet 214a. The fan 290′ is, for example, an axial fan.

In view of the above, merely one first fuel cell module is disposed in the interior space of the first part of the case of the fuel cell device, such that the gas flow channel in the interior space of the first part has a relative large space, thus increasing the flow of the reacting gas supplied to the first fuel cell module. Further, as the height of the second part of the case is higher, even a plurality of second fuel cell modules is disposed in the interior space of the second part, there is still sufficient space for the gas flow channel in the interior space of the second part, so the reacting gas is sufficiently supplied to the second fuel cell modules. Therefore, the fuel cell device has preferable power generating efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell device, for being inserted into an expansion slot of an electronic device, comprising:
a case, having a first part and a second part connected to the first part, wherein when the fuel cell device is inserted into the expansion slot, the first part is inside the expansion slot, the second part is outside the expansion slot, and a height of an interior space of the first part is lower than that of an interior space of the second part;
a first fuel cell module, disposed in the interior space of the first part;
a plurality of second fuel cell modules, arranged in the interior space of the second part along a height direction of the interior space of the second part, wherein the second fuel cell modules are separated from each other by a certain distance;
a connecting interface, disposed at the case, for being electrically connected to the expansion slot; and
a power management module, disposed inside the case, and electrically connected to the first fuel cell module, the second fuel cell modules and the connecting interface.

2. The fuel cell device as claimed in claim 1, wherein the first fuel cell module extends under of the second fuel cell modules.

3. The fuel cell device as claimed in claim 1, wherein the first part has a gas inlet, the second part has a gas outlet, and the first fuel cell module and the second fuel cell modules are disposed between the gas inlet and the gas outlet.

4. The fuel cell device as claimed in claim 3, further comprising at least one fan, disposed between the first fuel cell module and the gas inlet and adjacent to the gas inlet.

5. The fuel cell device as claimed in claim 3, further comprising at least one fan, disposed between the second fuel cell modules and the gas outlet and being adjacent to the gas outlet.

6. The fuel cell device as claimed in claim 1, wherein the power management module is disposed in the interior space of the first part.

7. The fuel cell device as claimed in claim 1, wherein the power management module comprises a boost DC/DC converter and a control unit.

8. The fuel cell device as claimed in claim 1, wherein an output power of the first fuel cell module is higher than that of each of the second fuel cell modules.

9. The fuel cell device as claimed in claim 1, wherein a size of the first fuel cell module is larger than that of each of the second fuel cell modules.

10. The fuel cell device as claimed in claim 1, further comprising:
a fuel cartridge, disposed in the case;
a mixing tank, disposed in the case and connected to the fuel cartridge, the first fuel cell module, and the second fuel cell modules;
a first pump, disposed in the case, for introducing the fuel in the fuel cartridge into the mixing tank; and
a second pump, disposed in the case, for introducing the fuel in the mixing tank into the first fuel cell module and the second fuel cell modules.

11. The fuel cell device as claimed in claim 10, wherein the fuel cartridge, the mixing tank, the first pump, and the second pump are disposed in the interior space of the second part.
